(19) United States
(12) Patent Application Publication
(10) Pub. No.: US 2010/0087180 A1
(43) Pub. Date: Apr. 8, 2010

(54) COMMUNICATIONS SYSTEMS

(75) Inventor: Jeffrey Wilson, Southampton (GB)

Correspondence Address: Vierra Magen Marcus & DeNiro LLP, 575 Market Street, Suite 2500, San Francisco, CA, 94105, US

(73) Assignee: Intellprop Limited, St. Peter Port (GB)

(21) Appl. No.: 12/445,035

(22) PCT Filed: Oct. 11, 2007
(86) PCT No.: PCT/GB2007/003873

§ 371 Date: Nov. 25, 2009

(30) Foreign Application Priority Data
Oct. 11, 2006 (GB) 0620161.0
Mar. 21, 2007 (GB) 0705425.7
Mar. 21, 2007 (GB) 0705426.5

(51) Int. Cl. H04M 3/00; H04W 4/12

(52) U.S. Cl. 455/418; 455/466

(57) ABSTRACT

A mobile telephone network (1) has associated with it an automated call response system (2) and an automated text message processing system (3), which are coupled to each other via a control link or path (4). The automated text message processing system (3) includes processing and intelligence to allow it to control the dialogue provided by the automated call response system (2) to a caller (5) on the basis of text messages that the automated text processing system (3) receives from the caller 5 during the call to the automated call response system (2). In this way, text messages sent by the caller 5 during the call- can control the voice dialogue provided for the call by the automated call response system (2) in real time.

The present invention relates to communications systems, and in particular to arrangements for automated interactions between a user and a communications system, such as between a user and a service provided on or via a communications system.

It is known in the art to provide interactive voice response systems, whereby a telephone user can engage in a dialogue with an automated response system, for example, to access a service, such as to purchase additional call-time credit. In such an arrangement, the automated response and dialogue may be fixed, or may be controlled, e.g., by DTMF or other terminal signalling means, and/or the user's speech input and/or one or more external databases or computers.

It is also known similarly to provide automated interactive text response systems, again whereby a user can engage in a text message (e.g. SMS message) dialogue with an automated response system, for example to access and use a text-message based service. Again, in such an arrangement, the text message dialogue may be fixed, or may be controlled by input text messages and/or one or more external databases and/or computers, etc.

However, notwithstanding the availability of such services, the Applicants believe that there remains scope for improvements to such automated services in and for communications networks.

According to a first aspect of the present invention, there is provided a system for providing an automated service or application to a user of a communications terminal of a communications system, the system comprising:

means for establishing a communications connection between a terminal of the communications system and the system for providing the automated service or application;

means for receiving a text message or messages from a terminal of the communications system during the connection of the terminal with the system for providing the automated service or application; and

means for controlling the operation of the system for providing the automated service or application during the communications connection on the basis of a text message sent to or for the system for providing the automated service or application during the communications connection.

According to a second aspect of the present invention, there is provided a method of providing an automated service or application to a user of a communications terminal in a communications system, the method comprising:

establishing a communications connection between a terminal of the communications system and an automated system of the communications system for providing the automated service or application;

the automated system of the communications system receiving a text message or messages from a terminal of the communications system during the connection of the terminal with the system for providing the automated service or application; and

controlling the operation of the system for providing the automated service or application during the communications connection on the basis of the text message sent to or for the system for providing the automated service or application during the communications connection.

The present invention provides an arrangement in which the operation of an automated system for providing a service or application in a communications system (such as the call dialogue provided by an automated call response system) is controlled in response to text messages that are sent whilst the connection (e.g. call) with the automated system is in progress. In other words, the present invention provides a system whereby text messages sent to or exchanged with an automated system for providing an application or service may be used to influence and control the actions and responses of the system during an ongoing communications connection (e.g. call) with the system.

Where the system for providing the application or service comprises, e.g., an automated call processing system and an automated text message processing system (which, as discussed below, is a preferred arrangement of the present invention), the present invention would allow, for example, a user who is currently engaged in a call to and dialogue with an automated call processing system of a communications system to simultaneously, during the call, send and/or exchange a text message or messages with an automated text message processing system of the communications system, for example thereby to influence and affect the call dialogue as the call proceeds.

As will be discussed further below, the Applicants have recognised that such an arrangement can provide a number of advantages and facilitate further and improved services and functionality in communications systems.

In particular, the Applicants have recognised that certain functions may only be done or may be better done in the context of a call, whereas other functions may only be done or may be better done by text messaging. The present invention allows these techniques to be combined to thereby offer new and improved functionality. It also facilitates, for example, providing a more integrated text messaging and simultaneous call service.

According to a third aspect of the present invention, there is provided a system for providing an automated service or application to a user of a communications terminal in a communications system, the system comprising:

means for controlling the operation of the system during a communications connection being processed by the system on the basis of a text message or messages sent whilst the communications connection being processed by the system is in progress.

According to a fourth aspect of the present invention, there is provided a method of operating a system for providing an automated service or application to a user of a communications terminal in a communications system, the method comprising:

controlling the operation of the system during a communications connection being processed by the system on the basis of a text message or messages sent whilst the communications connection being processed by the system is in progress.

The system for providing an automated service or application to a user of a communications terminal can take any suitable and desired form. In a particularly preferred embodiment it comprises an automated call response system. Most preferably, it also or instead, and preferably also, includes an automated text message processing system (which can then process the text message or messages that are sent during the communications connection).

Thus, in a particularly preferred embodiment, the present invention comprises means for or steps of establishing a communications connection with an automated call response system of the communications system, and controlling the operation of the automated call response system during the communications connection on the basis of a text message sent to an automated text message processing system during the communications connection.

It preferably further comprises a user, during the communications connection, sending a text message to, and/or means for allowing a user during the communications connection with the automated call response system to send a text message to, an automated text message processing system of the communications system.

Similarly, according to a fifth aspect of the present invention, there is provided an apparatus for a communications system, the apparatus comprising:

means for controlling the operation of an automated call response system of the communications system during a call being processed by that system on the basis of a text message or messages received by a text message processing system of the communications system whilst the call being processed by the automated call response system is in progress.

According to a sixth aspect of the present invention, there is provided a method of operating a communications system, the method comprising:

controlling the operation of an automated call response system of the communications system during a call being processed by that system on the basis of a text message or messages received by a text message processing system of the communications system whilst the call being processed by the automated call response system is in progress.

The automated call response system can be any suitable such system, such as an intelligent voice response system (for voice calls) or an intelligent video response system (for video calls) or both. It should provide an automated response to a call (a communications connection) made by a communications terminal. Thus, in a preferred embodiment, the system of the present invention comprises an automated call response system for providing an automated response to a call made by a communications terminal to or via the call response system.

The communications connection that is established to the system for providing an application or service (e.g. the automated call response system) may be any suitable such connection and may be set up and proceed in the normal manner for the communications system in question. It is preferably a voice and/or video connection, and is preferably a call, with (or to) the automated (e.g. call response) system. Thus in a preferred embodiment the invention comprises establishing a call with the automated (e.g. call response) system, and a or the user sends the text message, etc., during the call. It may, for example, be a voice call or a video call. In a preferred embodiment it is a voice call.

It should also be noted here that the communications connection is intended to be more than the sending of a text (short) message. Rather, it is a connection, such as a call, that can and will have, e.g., a “live” duration (in real-time) and, e.g., will require setting up (establishing) and terminating (clearing), and, e.g., will remain in progress until it is terminated.

The communications connection (e.g. call) may be, and in a preferred embodiment is, established by the user who is to participate in the connection (call) (for example by the user dialling the number to call the relevant service). However, this is not essential, and the connection could, for example, instead be established (made) by a third party user and then transferred to the user who is to participate in the connection (e.g. call). It would also be possible for the connection (e.g. call) to be established by or via the communications system initiating the connection to the user. This could be the case, for example, where a user requests (for example via a text message) a service of the communications system to call them back to establish the call. As will be appreciated by those skilled in the art, the present invention is, unless the context otherwise requires, applicable however the communications connection (e.g. call) in question is initially established.

The automated text message processing system (where provided) may similarly comprise any suitable such system. It is preferably an automated text message response system, such as an intelligent text response system. It preferably comprises suitable functionality, such as a text message processing engine, to allow it to identify and process appropriate information (such as content) from a received text message. It should provide automated processing of text messages that are sent to or via it. Thus, in a preferred embodiment, the system of the present invention comprises an automated text message processing system for providing automated processing of text messages sent to or via the text message processing system.

The text message or messages that are sent during the communications connection can be sent via any suitable text messaging (short messaging) system and arrangement. There may be one text message that is sent during the connection or there may be plural text messages sent, with, for example, some or all of the messages being used to control and influence the call.

In a preferred embodiment, the GSM SMS (short message service) text messaging arrangement is used, as a GSM terminal can send and receive text (SMS) messages during a call. However, any other suitable text messaging arrangement that allows a text message (a short message) to be sent during a (voice or video) communications connection (during a call) could be used instead or as well. An example of such an alternative text messaging arrangement would be a suitable Instant Messaging arrangement. It would also be possible to use a suitable email arrangement to send the text message (and thus references to text messages or messaging in the present application should be understood to include the sending of emails and emailing, unless the context requires otherwise).

In a particularly preferred embodiment, the text messaging arrangement and systems comprise a system that is usable via and that allows a text message to be sent by a communications terminal, and more preferably a handset, most preferably of a mobile communications system. The text messaging arrangement and systems thus most preferably comprise a suitable telephony system, preferably a mobile telephony system, short message, e.g., text messaging, system, such as, and preferably, the GSM SMS system, the North American IS41 SMS system and/or the 3GPP SMS system. Preferably the GSM and/or the North American IS41 SMS system is used.

In a particularly preferred embodiment, the text messages (e.g. SMS messages) sent to the automated text message processing system are delivered using the so-called “direct delivery” method, rather than the so-called “store and forward” method. This helps to avoid delays (particularly delays that may not be apparent to the sender) in delivery of the text messages to the automated text message processing system (which delays would be undesirable in the context of a system where text messages are to influence an ongoing, live, telephone call). Most preferably, so-called “transaction mode” delivery is used (i.e. where an acknowledgement is only sent to the sending terminal once acknowledgement has been received from the delivery destination (e.g., in the present case, the text message processing system, for example).

In a particularly preferred embodiment, the text message or messages is (or are) sent by the user who is using the application or service (who is participating in the communications connection (call)). Thus, in a preferred embodiment, the text message or messages are sent by, and received from, the communications terminal with which the communication connection with the system for providing an automated application or service is or has been established.

The text message or messages sent to the automated text message processing system can be used to control the operation of the automated call response system in any desired and suitable manner. In a particularly preferred embodiment, the text message or messages are used to control a dialogue that is being provided by the automated call response system (e.g. and preferably, the dialogue of the call that is in progress with the automated call response system). Most preferably a response or the response or responses sent to the caller by the automated call response system are controlled, and, e.g., selected or varied, on the basis of the text message or messages.

Thus, according to a seventh aspect of the present invention, there is provided a system for providing an automated service or application to a user of a communications terminal of a communications system, the system comprising:

means for providing automatically an audio and/or video dialogue to a terminal of the communications system; and

means for controlling automatically the dialogue that is provided to the terminal in response to a text message or messages sent by a or the terminal of the communications system during the provision of the audio and/or video dialogue to the terminal.

According to an eighth aspect of the present invention, there is provided a method of providing an automated service or application to a user of a communications terminal in a communications system, the method comprising:

an automated application or service provisioning system or means of the communications system:

providing an audio and/or video dialogue to a terminal of the communications system; and

controlling the dialogue that is provided to the terminal in response to a text message or messages sent by a or the terminal of the communications system during the provision of the audio and/or video dialogue to the terminal.

According to a ninth aspect of the present invention, there is provided a system for providing an automated service or application to a user of a communications terminal of a communications system, the system comprising:

means for providing automatically an audio and/or video dialogue to a terminal of the communications system; and

means for receiving a text message or messages from a or the terminal of the communications system during the provision of the audio and/or video dialogue to the terminal.

According to a tenth aspect of the present invention, there is provided a method of providing an automated service or application to a user of a communications terminal in a communications system, the method comprising:

an automated application or service provisioning system or means of the communications system providing an audio and/or video dialogue to a terminal of the communications system; and

a or the terminal of the communications system sending one or more text messages to or for the automated application or service provisioning system or means during the provision of the audio and/or video dialogue to the terminal.

According to an eleventh aspect of the present invention, there is provided a system for providing an automated service or application to a user of a communications terminal of a communications system, the system comprising:

means for establishing a communications connection between a terminal of the communications system and the system for providing the automated service or application; and

means for both providing automatically an audio and/or video dialogue to the terminal of the communications system and for receiving a text message or messages from a or the terminal of the communications system during the connection of the terminal with the system for providing the automated service or application.

According to a twelfth aspect of the present invention, there is provided a method of providing an automated service or application to a user of a communications terminal in a communications system, the method comprising:

establishing a communications connection between a terminal of the communications system and an automated system of the communications system for providing the automated service or application;

the system for providing the automated application or service providing an audio and/or video dialogue to the terminal of the communications system during the connection of the terminal with the system for providing the automated service or application; and

a or the terminal of the communications system sending one or more text messages to or for the system for providing the automated service or application during the connection of the terminal with the system for providing the automated service or application.

As will be appreciated by those skilled in the art, these aspects of the present invention can and preferably do include any one or more or all of the preferred and optional features of the present invention described herein, as appropriate.

In the case of a voice communications connection (e.g. call) to the automated service providing (e.g. call response) system, the audio dialogue, e.g., any audio response, to the caller should be controlled. In the case of a video communications connection (e.g. call), the video or audio, or both the video and audio, dialogue provided to the caller could be controlled in response to the received text message or messages, as desired.

The actual processing of the text message or messages to control the voice and/or video (call) dialogue can be carried out as and where desired in the communications system. For example, the automated system (e.g. the call response system or the automated text message processing system, or both) could perform some or all of this processing. Alternatively, or additionally, an external processing and control system could be used for some or all of this processing.

It will be appreciated by those skilled in the art that in the use of the system of the present invention, a (e.g. voice or video) communications connection (e.g. call) will need to be established to the automated service providing (e.g. call response) system, and, during the connection, a user will need to be able to send text messages (e.g. to a text message processing system). It will also be necessary for the system to be able to identify text messages that are associated with (that are to influence) the communications connection (e.g. call), dialogue, etc., in question.

In a preferred embodiment, the communications connection (e.g. call) to the automated service providing system (e.g. call response system) is set up in a normal manner for the communications system in question. As discussed above, this could be by the user who is to participate in the call dialling a given number or code to establish the call, by a third party user dialling the call and then transferring it to the user who is to participate in the call, or by the communications system (service) itself establishing the call with the user, etc.

The mechanism for sending text messages during the communications connection (e.g. call) can be selected as desired. For example, it would be possible to have a separate number or short code, etc., to which text messages are to be sent, which number, etc., is associated with the number used to set up the connection (for the call), so that the text messages can be identified as relating to the particular connection (call) in question.

It would also, for example, be possible to have a single or common number or short code, etc., to which text messages can be sent, with the system then, e.g., and preferably, identifying the connection (call) to which the text message relates from the caller's identity (e.g. CLI (calling line identity).

However, in a particularly preferred embodiment, the arrangement is such that text messages relating to a given connection (e.g. call) established with the automated service providing system are and can be directed to the same number (or short code, etc.) as was used to establish the connection (e.g. for the call). In other words, the same number, etc., is preferably used both for making the connection (call) to the automated system and for sending text messages during the connection (call). This facilitates more straightforward association between a text message and the connection (call) to which it relates.

Indeed, it is believed that this arrangement may be new and advantageous in its own right. Thus, according to a thirteenth aspect of the present invention, there is provided a method of communicating with a system for providing an automated service or application to a terminal in a communications system, the method comprising:

a user using the same number or code to direct a call to the system for providing an automated service or application and to send a text message or messages to or for the system for providing an automated service or application.

According to a fourteenth aspect of the present invention, there is provided a system for providing an automated service or application to a terminal of a communications system, comprising:

means for allowing a user to use the same number or code to direct a call to the system and to send a text message or messages to or for the system.

As will be appreciated by those skilled in the art, these aspects and arrangements of the invention can and preferably do include any one or more or all of the preferred and optional features of the invention described herein, as appropriate. Thus, for example, the system for providing an automated service or application preferably comprises an automated call response system and an automated text message processing system, and the method and system preferably comprise a user using, or means for allowing a user to use, the same number or code to direct a call to the automated call response system and to send a text message or messages to the automated text message processing system.

Similarly, the text message or messages to the same number or code as the call can preferably be sent and are preferably sent during the call (i.e. while the call is in progress), and/or preferably influence the dialogue of the call.

A further advantage of using the same number or code for text messages as the number or code for the connection (e.g. call), is that this can be used to facilitate more straightforward sending of a text message during the connection (call) by a user. For example, a search for the number to use for the text message may show up the call number as the last number used and therefore place it first in the search list.

In one preferred embodiment, the service or application is able to send and preferably does send a text message to the user (e.g., after the communication (call) with the application or service has been established), which text message includes a number to be used to send text messages to the system (i.e. gives the user the number to use for sending text messages to the system).

In another preferred embodiment, the service or application is able to send and preferably does send a text message to the user (e.g., after the communication (call) with the application or service has been established), which text message the user can then reply to in order to send their text messages to or for the service or application. This provides a convenient mechanism for allowing a user to send text messages to or for the application or service.

It is believed that such an arrangement may be new and advantageous in its own right.

Thus, according to a fifteenth aspect of the present invention, there is provided a method of operating a communications system comprising an automated system for the provision of a service or application to a user of the communications system, the method comprising:

sending a text message to a communications terminal of the communications system to which text message a user can reply to direct text messages to or for an application or service that is being provided by the automated system for the provision of a service or application.

According to a sixteenth aspect of the present invention, there is provided an automated system for the provision of a service or application to a user of a communications system, the system comprising:

means for sending a text message to a communications terminal of the communications system to which text message a user can reply to direct text messages to or for an application or service that is being provided by the automated system for the provision of a service or application.

As will be appreciated by those skilled in the art, these aspects and embodiments of the present invention can and preferably do include any one or more or all of the preferred and optional features of the present invention described herein. Thus, for example, the automated service or application can preferably provide to the user (the communications terminal) both an audio or video dialogue.

It would also be possible to, for example, configure the communications terminal such that a single key press or a limited number of key presses can be used to send a text message to the number in question. This could be done, for example, and preferably, by configuring a programmable “soft” key of the communications terminal to activate the sending of the text message to the number in question.

Thus, in a particularly preferred embodiment, the communications terminal is configured such that one key press or more than one simple key presses can be used to send a text message to the number or code required to send a text message appropriately to the automated service providing system (e.g. the text message processing system). Similarly, a key or keys of the communications terminal can be and preferably are configured to be useable to send a text message to the number or code required to send a text message appropriately to the automated system.

In a particularly preferred such embodiment, as discussed above, the number or code that the soft key or key presses is configured to direct a text message to is the same number or code as was dialled to establish the connection (call) (voice or video). This will provide a particularly user-friendly arrangement for implementing the present invention, as a user could then readily send a text message to the text message processing system during an ongoing connection (call) to the automated service providing system, simply by using the appropriate soft key or key press or presses on their terminal, once they have prepared their text message.

Thus, in a particularly preferred embodiment, the communications terminal is configured such that one key press or more than one simple key presses can be used to send a text message to the same number or code, as appropriate, as an existing, preferably in progress, communications connection (e.g. call). Similarly, a key or keys of the communications terminal can be and preferably are configured to be useable to send a text message to the same number or code, as appropriate, as an existing, preferably in progress, communications connection (e.g. call). Most preferably in this arrangement, the display label for such a key operation is “To [symbol] ”.

Indeed, it is believed that the provision of a soft key arrangement for sending a text message to the same number or code as was used to establish a communications connection (e.g. call) that is in progress may be new and advantageous in its own right, since it provides, for example, a particularly convenient and user-friendly user interface for a user when, for example, the user may wish to send a text message while a call is in progress.

Thus, according to a seventeenth aspect of the present invention, there is provided a user interface system for a terminal of a communication system, comprising:

a key of the communications terminal that is configured to be operable to direct a text message to the same number or code as was used for a communications connection that is in progress on the communications terminal.

According to an eighteenth aspect of the present invention, there is provided a method of providing a user interface for a communications terminal of a communications system, the method comprising:

configuring a key of the communications terminal to be operable to direct a text message to the same number or code as was used for a communications connection that is in progress on the communications terminal.

As will be appreciated by those skilled in the art, these aspects and embodiments of the present invention can and preferably do include any one or more or all of the preferred and optional features of the invention described herein, as appropriate. Thus, for example, it is preferably a “soft” key of the communications terminal that is configured in this way.

The Applicants have further recognised that a similar arrangement could be used to direct a text message to the last number that was dialled on a communications terminal, and, moreover, that such an arrangement may be similarly advantageous in terms of user-convenience, etc., in the appropriate circumstances.

For example, although in the particular context of the present invention, the need is to send a text message during a communications connection (e.g. call), there may be other situations where the need is to send a text message to the same number after a call has finished. For example, a user may call a customer service line which is busy and be invited to send their query by text message so that they can be called back later. In this case, the user may wish to send the text message to the number used for the call immediately after the call has finished (been cleared down) (and the user has prepared their text message).

Providing a soft key etc., that is configured to direct a text message to the number used for the last call provides a particularly user-friendly and convenient mechanism for this, as a user could then readily send a text message after a call simply by using the appropriate soft key or key press or presses on their terminal, once they have prepared their text message.

Thus, in a particularly preferred embodiment, the communications terminal is configured such that one key press or more than one simple key presses can be used to send a text message to the same number or code, as appropriate, as was used for the last communications connection (e.g., and preferably, call) of the terminal, such as, and preferably, the last dialled call of the terminal. Similarly, a key or keys of the communications terminal can be and preferably are configured to be useable to send a text message to the same number or code, as appropriate, as was used for the last communications connection of the terminal, such as, and preferably, the last dialled call of the terminal.

Most preferably in this, arrangement, the display label for such a key operation is “To [symbol] ”.

Indeed, it is believed that the provision of a soft key arrangement for sending a text message to the same number or code as was used to establish the last communications connection (e.g. dialled call) made via a terminal may be new and advantageous in its own right, since it provides, for example, a particularly convenient and user-friendly user interface for a user when, for example, the user may wish to send a text message after a call has finished.

Thus, according to a nineteenth aspect of the present invention, there is provided a user interface system for a terminal of a communication system, comprising:

a key of the communications terminal that is configured to be operable to direct a text message to the same number or code as was used for the last communications connection of the communications terminal.

According to a twentieth aspect of the present invention, there is provided a method of providing a user interface for a communications terminal of a communications system, the method comprising:

configuring a key of the communications terminal to be operable to direct a text message to the same number or code as was used for the last communications connection of the communications terminal.

As will be appreciated by those skilled in the art, these aspects and embodiments of the present invention can and preferably do include any one or more or all of the preferred and optional features of the invention described herein, as appropriate. Thus, for example, the communications connection is preferably a voice and/or video connection, and preferably a call. Similarly, it is preferably a “soft” key of the communications terminal that is configured in this way, and the number or code that the text message is directed to is preferably the number or code used for the last dialled call of or made via the communications terminal. Equally, the configured key can preferably be used to send a text message in this fashion after the connection (e.g. call) has finished (has been cleared).

The system of the present invention can be used as desired, such as, for example, in relation to any interactive service where a wide spectrum of response may be required. For example, it could be used for game applications, where, as part of a game that is being provided by or via an automated call response system, a user can text responses that are then used, for example, to control the progress of the game. Such a game could, e.g., comprise an interactive fiction-type game, and/or a maze game.

It is envisaged that the present invention may have particular application to quiz-type applications and services, such as, and in particular, a “Spelling Bee” type service. For example, a user could be asked questions, such as spellings, via the automated service providing system (e.g. call response system) as part of the call dialogue, and then send their answers by text message (e.g., and preferably, to an automated text processing system). The call dialogue could then be controlled, e.g. to provide an appropriate response, on the basis of the texted answer (e.g. whether the spelling is correct or not). Alternatively or additionally, a user could text a spelling of a word, and the automated (e.g. call response) system “speak” the word back to the user.

It is believed that the provision of a Spelling Bee service in the manner of the present invention may be new and advantageous in its own right. Thus, according to a twenty-first aspect of the present invention, there is provided a method of providing a Spelling Bee service for a communications system, the method comprising:

prompting a user to send by text message a spelling of a word to the service;

a user sending a text message including their spelling of the word to the service; and

the service assessing the user's text message to determine whether the spelling is correct or not, and responding to the user with a further prompt or message on the basis of whether the spelling is determined to be correct or not.

According to a twenty-second aspect of the present invention, there is provided a system for a Spelling Bee service for a communications system, the system comprising:

means for prompting a user to send by text message a spelling of a word to the service;

means for receiving a user's text message including their spelling of the word; and

means for assessing the user's text message to determine whether the spelling is correct or not, and for responding to the user with a further prompt or message on the basis of whether the spelling is determined to be correct or not.

As will be appreciated by those skilled in the art, these aspects of the invention can and preferably do include any one or more or all of the preferred and optional features of the invention described herein, as appropriate. Thus, for example, the prompts to the user to submit spellings are preferably audio and/or video prompts, and are most preferably sent via an automated call response system of the communications system. Similarly, a call is preferably first established with the Spelling Bee service via an automated call response system of the communications system, and then the user sends their spellings by text message to the service while the call is in progress, with the dialogue of the call being controlled in accordance with the user's text message responses. Equally, the user is preferably prompted for plural spellings in succession, and sends a text message for each spelling in turn.

As will be appreciated by those skilled in the art, as well as being useful for game and quiz-type applications and services as discussed above, the present invention could equally be used in other contexts.

For example, where a user is participating in a call with another user, the present invention could be used to allow the user to send a text message during the call to trigger or prompt the operation of an automated system during the call, such as the playing of a previously stored audio or video file or recording during the call. This would allow, for example, a user to place a video call to a called party, and then, during the call, send a text message saying, for example, “Play the F1 Clip”, with the system in response providing the “F1 Clip” to both call parties so that they can view it. Similarly, where a call recording system or archive is available, such as a Telsis Callstore system, a text message could be sent during a call to trigger the playback of a previously recorded call during the current call.

Thus, in a particularly preferred embodiment, a text message sent during a call can be and is preferably used to control material sent to a call party or to the call parties during the call, and most preferably controls the presence or absence of material during the call.

Similarly, the system of the present invention, as well as being particularly applicable, as discussed above, to calls that are, in effect, made to automated call service equipment, can preferably be and preferably is also or instead applied to party-to-party (person-to-person, etc.,) calls, group conferencing calls, etc., with the sending of a text message during the call then being used, preferably, to control material sent or provided to some or all of the parties to the call, or conference call, etc., during the call.

The Applicants further believe that such arrangements in which a text message sent during a call may be used to control the provision of automated services during the call may be new and advantageous in its own right, and not just in the context of or also in combination with the use of text message responses to control a call dialogue with an automated call response system.

Thus, according to a twenty-sixth aspect of the present invention, there is provided a method of operating a communications system, the method comprising:

establishing a communications connection in the communications system;

a user, during the communications connection, sending a text message; and

controlling the operation of an automated service of the communications system during the communications connection on the basis of the text message sent during the communications connection.

According to a twenty-seventh aspect of the present invention, there is provided a system for use with a communications system, the system comprising:

means for establishing a communications connection;

means for allowing a user to send a text message during the communications connection; and

means for controlling the operation of an automated service of the communications system during the communications connection on the basis of a text message sent during the communications connection.

According to an twenty-eighth aspect of the present invention, there is provided an apparatus for a communications system, the apparatus comprising:

means for controlling the operation of an automated service of the communications system during a communications connection on the basis of a text message sent whilst the communication connection is in progress.

According to a twenty-ninth aspect of the present invention, there is provided a method of operating a communications system, the method comprising:

controlling the operation of an automated service of the communications system during a communications connection on the basis of a text message sent whilst the communications connection is in progress.

As will be appreciated by those skilled in the art, these aspects and embodiments of the invention can and preferably do include any one or more or all of the preferred and optional features of the invention described herein, as appropriate.

Thus, for example, the communications connection is preferably in the form of a call, and/or the automated service or operation of the communications system that is controlled on the basis of the text message preferably comprises an automated system of the communications system for providing material to a party or to the party or parties to the connection (call), such as, and preferably, the playback of a pre-recorded video and/or audio clip, preferably during the connection (call). It could also be, as discussed above, the dialogue with an automated call response system that is controlled by the text message that is sent.

Similarly, the text message is preferably sent to or received during the connection (while the call is in progress) by an automated (text message) processing system of the communications system and preferably is directed to the same number or code as was used to establish the connection (call).

In these arrangements and aspects of the invention, the connection (call) may be, and in a preferred embodiment is, established between two or more users of the communications system. Thus it is preferably a two (or more) party call (connection).

Preferably the initial connection (call) is set up via or using an automated telephony system or call processing system of the communications system to facilitate this operation, even though the connection (call) itself may be between two (or more) users of the system, with the automated system then providing services, such as material for the call, in response to text messages sent during the call, as discussed above.

As will be appreciated by those skilled in the art, it would be possible for the automated service or application providing system (e.g. call response system and automated text message processing system) to provide multiple different applications for users to access, with each application, for example, being accessed by making a call to a particular number or code associated with the application in question, or by making a call to a single number or code that then accesses a menu system via which the different applications can be selected and activated.

It would also be possible for multiple users to simultaneously participate in the same call and, e.g., to send text messages to influence the call dialogue. This could be achieved, for example, by providing a service having a common, single audio stream that can be listened to by each of plural users and which supports multiple, different text message senders (responding) during the call.

Thus, although in one preferred embodiment it is the same user who made the communications connection (e.g. call) to the automated service providing system (e.g. call response system) who sends the text message or messages that influence the, e.g., call dialogue, this need not be the case, and in another preferred embodiment, a different user (terminal) may send a text message (e.g. to or via the automated text response system) to influence, e.g., a call by or of another user. Similarly, more than one user may, if desired, be able to send text messages that influence the service (call).

This would allow, for example, multiple users to play the same application, such as a quiz, simultaneously. In such a case each user could basically listen to (participate in) the same call dialogue, but be able to send text messages independently to the system. It would also be possible, e.g., for the call dialogue to be varied depending upon the text messages received.

The present invention can be applied in any suitable telephone (telecommunications) system and network (namely a system that can support both calls and text messaging). It is particularly, but not exclusively, suited to mobile telephony networks, such as GSM and 3G networks, and thus in a preferred embodiment, the communications system includes or is a mobile telephony communications system. However, the invention could also be applied in appropriately arranged fixed networks, if desired.

Similarly, the communications terminal to be used by a user in the present invention can be any suitable such terminal (i.e. a terminal that can make calls and send text messages). It is, as discussed above, preferably a mobile telephony (communications) terminal, and preferably a handset.

It should also be noted here that the various components of the system may be distributed across a or the communications network or networks, and there may be duplicate sets of components if desired. Equally, the system may be operable across a plurality of different networks (e.g. networks of different service providers and/or countries, etc.), and preferably can support and be used by communications terminals that have roamed to foreign networks. Techniques such as the use of virtual mobile numbers may be used to facilitate this, if desired and as appropriate.

Although the present invention has been described above with particular reference to the text messages sent by a or the user controlling and influencing the dialogue of the call with an automated call response system, the Applicants have further recognised that it would also be possible for the dialogue with the or provided by the system (e.g. call response system) to influence or control the operation of a or the text message processing system.

For example, in the context of a quiz-type application as discussed above, the question that is posed during the call dialogue will govern the text message response that the system (the text message processing system) is looking for, and accordingly the operation of the text message processing system in response to any text message that is received at or after that point in the call. It would also, for example, be possible for the text message processing system to be configured to provide text message responses to a caller during a call, depending, for example, on the dialogue that is taking place with the system (e.g. the automated call response system).

Thus, in a particularly preferred embodiment of the present invention, it is also possible for the call dialogue to control the operation of a or the text message processing system. Thus, in a particularly preferred embodiment, the present invention further comprises means for or a step of controlling the text message processing on the basis of the dialogue of the communication (call) between the automated system and the user.

The Applicants further believe that an arrangement in which a call dialogue with an automated service providing system is used to control the operation of a text message processing means (e.g. to control the expected text message responses; or text message responses sent to a user during the call) may be new and advantageous in its own right, and not just in the context of or also in combination with the use of text message responses to control a call dialogue.

Thus, according to a thirtieth aspect of the present invention, there is provided a method of operating a communications system, the method comprising:

establishing a communications connection with an automated call response system of the communications system;

a user, during the communications connection, sending a text message to or receiving a text message from an automated text message processing system of the communications system; and

controlling the operation of the automated text message processing system during the communications connection on the basis of the dialogue with or via the automated call response system during the communications connection.

According to a thirty-first aspect of the present invention, there is provided a system for use with a communications system, the system comprising:

means for establishing a communications connection with an automated call response system of the communications system;

means for allowing a user during the communications connection with the automated call response system, to send a text message to or to receive a text message from an automated text message processing system of the communications system; and

means for controlling the operation of the automated text message processing system during the communications connection on the basis of the dialogue with or via the automated call response system during the communications connection.

According to a thirty-second aspect of the present invention, there is provided an apparatus for a communications system, the apparatus comprising:

means for controlling the operation of an automated text message processing system of the communications system on the basis of the dialogue of a communications connection with or via an automated call response system of the communications system whilst the communications connection is in progress.

According to a thirty-third aspect of the present invention, there is provided a method of operating a communications system, the method comprising:

controlling the operation of an automated text message processing system of the communications system on the basis of the dialogue of a communications connection with or via an automated call response system of the communications system whilst the communications connection is in progress.

As will be appreciated by those skilled in the art, these aspects and embodiments of the invention can and preferably do include any one or more or all of the preferred and optional features of the invention described herein, as appropriate. Thus, for example, as discussed above, the call to the automated call response system and the text messages sent to the text messaging system are preferably sent using the same number or code. Similarly, the communications connection in question may be a voice or video connection (e.g. call), and a preferred application of the arrangement is in the context of quiz-type services, such as a “Spelling Bee” service.

It can be seen from the above that in general terms, the present invention provides a communications system in which the operation of an automated system of the communications system is controlled in response to a text message or messages that are sent whilst a communication connection is in progress, and a system for a communications system in which a text message or messages sent during a communications connection may be used to influence and control the operation of an automated system of the communications system.

As will be appreciated by those skilled in the art, all of the aspects and embodiments of the invention described herein may and preferably do include any one or more or all of the preferred and optional features of the invention described herein, as appropriate.

The methods in accordance with the present invention may be implemented at least partially using software e.g. computer programs. It will thus be seen that when viewed from further aspects the present invention provides computer software specifically adapted to carry out a method or the methods herein described when installed on data processing means, a computer program element comprising computer software code portions for performing a method or the methods herein described when the program element is run on data processing means, and a computer program comprising code means adapted to perform all the steps of a method or of the methods herein described when the program is run on a data-processing system. The invention also extends to a computer software carrier comprising such software which when used to operate a communications system comprising data processing means causes in conjunction with said data processing means said system to carry out the steps of the method of the present invention. Such a computer software carrier could be a physical storage medium such as a ROM chip, CD ROM or disk, or could be a signal such as an electronic signal over wires, an optical signal or a radio signal such as to a satellite or the like.

It will further be appreciated that not all steps of the method of the invention need be carried out by computer software and thus from a further broad aspect the present invention provides computer software and such software installed on a computer software carrier for carrying out at least one of the steps of the methods set out herein.

The present invention may accordingly suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

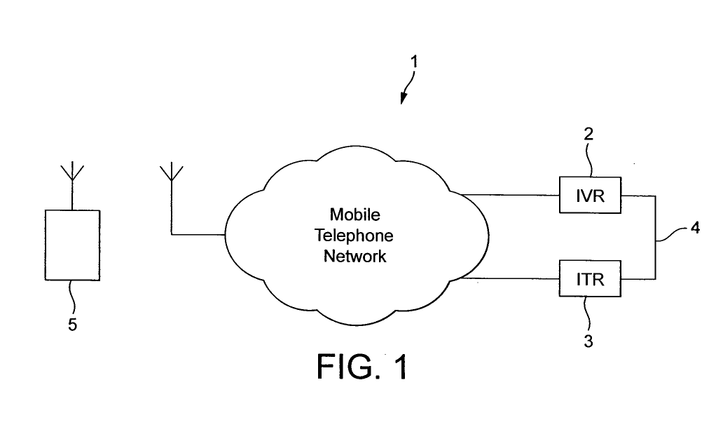

A number of preferred embodiments of the present invention will now be described by way of example only and with reference to the accompanying drawing, FIG. 1, which shows schematically a communications system that can be operated in accordance with the present invention.

The communications system shown in FIG. 1 comprises a mobile telephone (communications) network 1, which in the present embodiment is a GSM network. (However, other mobile communications networks, such as 3G networks could be used, as could, if desired, appropriate fixed line networks or, indeed, combinations of mobile and fixed line networks.)

The mobile telephone network 1 has associated with it a system for providing an automated application or service to users of the system. This system comprises, in the present embodiment, an automated call response system 2, and an automated text message processing system 3.

The automated call response system 2 is, in the present embodiment, in the form of an intelligent voice response system (IVR). Other arrangements for this automated call response system, such as an intelligent video response system, would be possible. The intelligence voice response system 2 can, as is known in the art, engage in a dialogue with a telephone user who makes a call to the intelligence voice response system 2, which dialogue may, for example, be controlled by DTMF and/or other terminal-based signalling means and/or speech input and/or one or more external databases and/or computers.

The automated text message processing system 3 is, in the present embodiment, in the form of an intelligent text response system (ITR). This system allows, as is known in the art, telephone users to send a text message to the intelligent text response system 3 and engage in a text message-based dialogue that may, for example, be controlled by one or more input text messages and/or one or more external databases and/or computers.

In the present embodiment, in accordance with the present invention, and as shown in FIG. 1, the automated call response system 2 and the automated text message processing system 3 are coupled to each other via a control link or path 4. This allows, as will be discussed further below, text messages received by the automated text message processing system 3 to be used to influence the dialogue of a call with the automated call processing system 2, and vice-versa.

The automated text message processing system 3 accordingly also includes appropriate processing and intelligence to allow it to control the dialogue of the automated call response system 2 with a caller on the basis of text messages that the automated text processing system 3 receives during a call to the automated call response system 2. In this way, text messages received by the automated text processing system 3 during a call, can control the voice and dialogue provided by the automated call response system 2 in real time.

(Although in the present embodiment the processing to allow the text messages to control the dialogue of the call with the caller is provided in the automated text processing system 3, it is possible for this processing and intelligence to be provided and located elsewhere, such as in the automated call response system 2, or externally, or distributed across these various components.)

FIG. 1 also shows a mobile communications terminal 5, in the form of a mobile handset, which may communicate with the automated call response system 2 and the intelligent text processing means 3 via the mobile telephone network 1, as is known in the art. (As will be appreciated by those skilled in the art, in practice there will be many communications terminals that are using the mobile telephone network 1. FIG. 1 shows a single terminal for simplicity.)

The mobile handset 5 is a GSM handset, and can, as is known in the art, send and receive text messages (SMS) messages during a voice call.

In use of the system of the present embodiment in accordance with the present invention, the user of the mobile terminal 5 will first dial an appropriate number to call a service provided by the automated call response system 2. The user then engages in a call with the service provided by the automated call response system 2. During the call, the user is able to send text messages to the automated text message processing system 3. The received text messages are then used by the automated text messaging system 3, to control the dialogue of the call between the automated call response system 2 and the caller.

In the present embodiment, in order to send text messages to the automated text processing system during the call with the automated call response system 2 (while the call is in progress), the user sends those text messages to the same number as was used to place the call to the automated call response system 2. This simplifies the operation from the user's perspective.

In the present embodiment, the mobile terminal 5 is modified so that one or more simple key presses (soft keys) can be used to send a text message to the same number as that of the existing voice call. The numeric (display) for this soft key press is set to “To [symbol] ”.

However, it would also be possible to use different numbers for sending the text messages, if desired. For example, there could be a single common number for text messages to be sent to, with the caller's identity (e.g. calling line identity) then being used to identify which call with the automated call response system 2 a given received text message relates to.

In the present embodiment, text messages are sent to the automated text message processing system 3 using the so-called “transaction mode” delivery method for text messages. As is known in the art, in transaction mode the text message is delivered “directly” to its destination, without passing it via a store and forward arrangement, and its delivery not acknowledged by the system and hence the network until it is accepted by the text message processing system (ITR) 3. In this way, a user knows that a “message sent” message on his or her handset means the message has been delivered to its destination.

An example of a service to which the present invention can be applied will now be described. The present example is a “Spelling Bee” service, but the present invention could equally be applied to other services, such as games or quiz-type services, or indeed to any other interactive service where a wide spectrum of response could be required.

In the case of the exemplary Spelling Bee service, the user 5 would first call the number to activate the Spelling Bee service provided via an automated call response unit 2. The automated call response unit 2 would then respond with a prompt, such as, for example,
“Welcome to Spelling Bee. I will ask you to spell ten words. After each word text your spelling of that word to this number—so that you are not tempted to cheat we recommend turning off your predictive text feature.

Let's begin.

Your first word is “ ”

Please text in your spelling now”

In response to this, the user would then prepare a text message containing their spelling of the word in question, and then send that text message to the automated text processing system 3 using the same number as was used to call the Spelling Bee service.

When it receives the user's text message, the automated text processing system 3 will analyse the text message and, for example, determine whether the spelling is correct or not. It will then instruct the automated call response system 2 via the control path 4 accordingly, so that the dialogue provided by the automated call response system 2 can be controlled according to the text message sent by the user.

For example, if the user's spelling is correct, then the automated text response system 3 could instruct the automated call response system 2 providing the Spelling Bee service to respond with the dialogue

“That's absolutely right. Very good 1/1!
Let's see how you get on with your second word which is “ ”.

That's “ ”.

Please text now.”

and so on.

Once the user has finished the call, or completed a set of spellings, etc., the system could send and preferably does send to the user a text message containing the correct spellings of any words that the user has misspelled or didn't know, or the correct spellings of all the words that the user has attempted to spell. Other arrangements would, of course, be possible.

Although the present example has been described with reference to a single user using the service in question, it would, as will be appreciated by those skilled in the art, be possible for multiple callers to be using the same service, either independently or collectively. In the latter case, the automated call response system 2 could provide a service or application providing a single audio stream that can be accessed by plural users simultaneously, with text messages from the group of users participating in the service (call) then be used to control the audio stream dialogue.

Similarly, although the present embodiment has been described with particular reference to a GSM mobile telephone system and the use of a GSM handset, as will be appreciated by those skilled in the art, the present invention could equally be applied to other communications systems, such as other mobile communications systems. In effect, the present invention can be applied to any communications system where a communications terminal can send and/or receive text messages during a call, or indeed to any set of communication systems where a voice and/or video channel is provided by any appropriate means, such as by television or radio, etc., and text message input from a communications terminal (e.g. handset) is possible during an ongoing communication via the voice or video channel.

It can be seen that the present invention provides, in its preferred embodiments at least, a system that combines the use of both text messaging and voice or video call functionality, to offer new and advantageous functionality in a communications system.

This is achieved, in the preferred embodiments of the present invention at least, by a user, during a call to an automated call response system, sending text messages to an automated text message processing system and the system then controlling the call dialogue in real time in response to the text messages that are sent.

1. A method of providing an automated service or application to a user of a mobile telephony communications terminal in a mobile telephony communications system, the method comprising:
establishing a communications connection between a mobile telephony terminal of the communications system and an automated system of the communications system for providing the automated service or application;
the automated system of the communications system receiving a text message or messages from a mobile telephony terminal of the communications system during the connection of the mobile telephony terminal with the system for providing the automated service or application; and
controlling the operation of the system for providing the automated service or application during the communications connection on the basis of the text message sent to or for the system for providing the automated service or application during the communications connection; wherein:
the controlling of the operation of the system for providing the automated service or application during the communications connection on the basis of a text message sent to or for the system for providing the automated service or application during the communications connection comprises:
controlling an audio and/or video dialogue provided by the system for providing an automated application or service whilst the communications connection is in progress with the mobile telephony terminal on the basis of the text message or messages.

2. The method of claim 1, wherein the same number is used both for making the communications connection to the system for providing an automated application or service and for sending the text message or messages during the communications connection.

3. The method of claim 1, wherein the system for providing an automated application or service provides a game and/or quiz service.

4. The method of claim 1, further comprising controlling material sent to a call party or to the call parties during a call on the basis of a text message sent during the call.

5. The method of claim 1, further comprising:
establishing a communications connection with an automated call response system of the communications system;
a user, during the communications connection, sending a text message to or receiving a text message from an automated text message processing system of the communications system; and
controlling the operation of the automated text message processing system during the communications connection on the basis of the dialogue with or via the automated call response system during the communications connection.

6. The method of claim 1, further comprising providing a Spelling Bee service by:
prompting a user to send by text message a spelling of a word to the service;
a user sending a text message including their spelling of the word to the service; and
the service assessing the user's text message to determine whether the spelling is correct or not, and responding to the user with a further prompt or message on the basis of whether the spelling is determined to be correct or not.

7. A system for providing an automated service or application to a user of a mobile telephony communications terminal of a mobile telephony communications system, the system comprising:
means for establishing a communications connection between a mobile telephony terminal of the communications system and the system for providing the automated service or application;
means for receiving a text message or messages from a mobile telephony terminal of the communications system during the connection of the terminal with the system for providing the automated service or application; and
means for controlling the operation of the system for providing the automated service or application during the communications connection on the basis of a text message sent to or for the system for providing the automated service or application during the communications connection; wherein:
the means for controlling of the operation of the system for providing the automated service or application during the communications connection on the basis of a text message sent to or for the system for providing the automated service or application during the communications connection comprises:
means for controlling an audio and/or video dialogue provided by the system for providing an automated application or service whilst the communications connection is in progress with the mobile telephony terminal on the basis of the text message or messages.

8. The system of claim 7, wherein the same number can be used both for making the communications connection to the system for providing an automated application or service and for sending the text message or messages during the communications connection.

9. The system of claim 7, wherein the system for providing an automated application or service provides a game and/or quiz service.

10. The system of claim 7, further comprising means for controlling material sent to a call party or to the call parties during a call on the basis of a text message sent during the call.

11. The system of claim 7, further comprising:
means for establishing a communications connection with an automated call response system of the communications system;
means for allowing a user during the communications connection with the automated call response system, to send a text message to or to receive a text message from an automated text message processing system of the communications system; and
means for controlling the operation of the automated text message processing system during the communications connection on the basis of the dialogue with or via the automated call response system during the communications connection.

12. The system of claim 7, further comprising means for providing a Spelling Bee service, comprising:
means for prompting a user to send by text message a spelling of a word to the service;
means for receiving a user's text message including their spelling of the word; and
means for assessing the user's text message to determine whether the spelling is correct or not, and for responding to the user with a further prompt or message on the basis of whether the spelling is determined to be correct or not.

13.-16. (canceled)

17. One or more computer readable storage devices having computer readable code embodied on the computer readable storage devices, the computer readable code for programming one or more computers to perform a method comprising:
establishing a communications connection between a mobile telephony terminal of a communications system and an automated system of the communications system for providing an automated service or application;
the automated system of the communications system receiving a text message or messages from a mobile telephony terminal of the communications system during the connection of the mobile telephony terminal with the system for providing the automated service or application; and
controlling the operation of the system for providing the automated service or application during the communications connection on the basis of the text message sent to or for the system for providing the automated service or application during the communications connection; wherein:
the controlling of the operation of the system for providing the automated service or application during the communications connection on the basis of a text message sent to or for the system for providing the automated service or application during the communications connection comprises:
controlling an audio and/or video dialogue provided by the system for providing an automated application or service whilst the communications connection is in progress with the mobile telephony terminal on the basis of the text message or messages.

18. A system for providing an automated service or application to a user of a mobile telephony communications terminal of a mobile telephony communications system, the system comprising:
a call response computer that establishes a communications connection between a mobile telephony terminal of the communications system and provides the automated service or application;
a text message computer that receives a text message or messages from a mobile telephony terminal of the communications system during the connection of the terminal with the call response computer; and
a processor that controls the operation of the call response computer during the communications connection on the basis of a text message received by the text message computer during the communications connection; wherein the processor comprises a processor for controlling an audio and/or video dialogue provided by the call response computer whilst the communications connection is in progress with the mobile telephony terminal on the basis of the text message or messages.

19. The system of claim 18, wherein the same number can be used both for making the communications connection to the call response computer and for sending the text message or messages during the communications connection.

20. The system of claim 18, wherein the call response computer provides a game and/or quiz service.

21. The system of claim 18, further comprising a processor that controls material sent to a call party or to the call parties during a call on the basis of a text message sent during the call.

22. The system of claim 18, further comprising:
a computer that allows a user during the communications connection with the call response system to send a text message to or to receive a text message from the text message computer; and
a computer that controls the operation of the text message computer during the communications connection on the basis of the dialogue with or via the call response computer during the communications connection.

23. The system of claim 18, further comprising means for providing a Spelling Bee service, comprising:
means for prompting a user to send by text message a spelling of a word to the service;
means for receiving a user's text message including their spelling of the word; and
means for assessing the user's text message to determine whether the spelling is correct or not, and for responding to the user with a further prompt or message on the basis of whether the spelling is determined to be correct or not.
